(19) United States
(12) Patent Application Publication
(10) Pub. No.: US 2026/0301625 A1
(43) Pub. Date: Oct. 1, 2026

(54) EDGE DIMMING CONTROL DEVICE AND METHOD

(71) Applicant: LX SEMICON CO., LTD., Daejeon (KR)

(72) Inventors: Jong Sang YOO, Daejeon (KR); Jun Young PARK, Daejeon (KR); Kyung Won JEONG, Daejeon (KR); Jae Chan CHO, Daejeon (KR)

(73) Assignee: LX SEMICON CO., LTD., Daejeon (KR)

(21) Appl. No.: 19/479,234

(22) PCT Filed: Apr. 24, 2024
(86) PCT No.: PCT/KR2024/005534

§ 371 Date: Oct. 27, 2025

(30) Foreign Application Priority Data
Apr. 28, 2023 (KR) 10-2023-0056568

(51) Int. Cl. G09G 3/20

(52) U.S. Cl. CPC G09G 3/20; G09G 2310/04; G09G 2320/0686; G09G 2320/103; G09G 2330/021

(57) ABSTRACT

The present invention relates to an edge dimming control device and method for controlling dimming for a screen area where there is little or no change in image information. The device comprises a source module for providing a dimming command for an image frame, and a sink module for controlling the dimming of a display device on the basis of the dimming command. The sink module may, when the dimming command is input, obtain an updated region and a non-updated region in the image frame on the basis of the dimming command, identify whether the non-updated region is distinguished, calculate a dimming weight for the non-updated region if the non-updated region is distinguished, and control the dimming of the display device such that edge dimming is applied to the non-updated region of the image frame on the basis of the calculated dimming weight.

### TECHNICAL FIELD

The present disclosure relates to a dimming control device, and more particularly, to an edge dimming control device and method for controlling dimming in a screen area where image information changes little or not.

### BACKGROUND ART

In general, a display device can consume a lot of power because various image information is displayed.

The display device is continuously turned on while providing image information to a user. However, since the display device has to continuously output light during the turn-on period, their power consumption is higher than that of other components in an electronic device.

Therefore, the display device can reduce power consumption by reducing the brightness of certain screen areas where the image does not change.

However, reducing brightness in areas where the image remains unchanged still results in unnecessary power consumption and a perceived visual unnaturalness for the user, as the screen brightness of the current frame remains the same as that of the previous frame or gradually decreases from the center to the edges of the image.

Alternatively, the display device could reduce power consumption by reducing the brightness of the entire screen areas.

However, this approach also reduces the brightness of both the visible and invisible areas in the entire screen areas, resulting in a perceived visual unnaturalness for the user.

Therefore, the development of an edge dimming control device is needed that can actively or passively control dimming in areas where the image information is either unchanging or relatively unchanged, based on image information, thereby reducing power consumption and providing a natural-looking image.

### DETAILED DESCRIPTION OF THE INVENTION

### Technical Problem

The present disclosure aims to solve the aforementioned problems and other problems.

The present disclosure aims to provide an edge dimming control device and method that can reduce power consumption and provide natural images to the user by actively or passively controlling edge dimming for non-updated regions of an image frame based on image information.

### Technical Solution

An edge dimming control device according to one embodiment of the present disclosure is an edge dimming control device that controls dimming of a display device, and may include a source module configured to provide a dimming command for an image frame; and a sink module configured to control dimming of the display device based on the dimming command, wherein the sink module is configured to, when the dimming command is input, obtain an updated region and a non-updated region of the image frame based on the dimming command, determine whether the non-updated region is identified, calculate a dimming weight for the non-updated region when the non-updated region is identified, and control dimming of the display device such that edge dimming is applied to the non-updated region of the image frame based on the calculated dimming weight.

A display device according to one embodiment of the present disclosure may include a display configured to display an image; and an edge dimming control device configured to control dimming of the display, wherein the edge dimming control device comprises: a source module configured to provide a dimming command for an image frame; and a sink module configured to control dimming of the display device based on the dimming command, wherein the sink module is configured to, when the dimming command is input, obtain an updated region and a non-updated region of the image frame based on the dimming command, determine whether the non-updated region is identified, calculate a dimming weight for the non-updated region when the non-updated region is identified, and control dimming of the display such that edge dimming is applied to the non-updated region of the image frame based on the calculated dimming weight.

An edge dimming control method of an edge dimming control device according to one embodiment of the present disclosure may include receiving an image frame and a dimming command; analyzing the dimming command; obtaining an updated region and a non-updated region of the image frame based on the dimming command, and determining whether the non-updated region is divided and identified into a plurality of divided regions; determining a divided region to be dimmed among the plurality of divided regions when the non-updated region is divided into the plurality of divided regions; calculating a dimming weight to be applied to the divided region to be dimmed; applying edge dimming to the non-updated region of the image frame based on the calculated dimming weight; and controlling dimming of the display device such that the applied edge dimming is output.

### Effects of the Invention

According to one embodiment of the present disclosure, by actively or passively controlling edge dimming for a non-updated region of an image frame based on image information, power consumption can be reduced and natural images can be provided to a user.

### BRIEF DESCRIPTION OF DRAWINGS

FIG. 1 is a diagram illustrating a dimming control system according to one embodiment of the present disclosure.

FIGS. 2 and 3 are diagrams illustrating an edge dimming control device according to one embodiment of the present disclosure.

FIG. 4 is a diagram illustrating a sink unit of an edge dimming control device according to one embodiment of the present disclosure.

FIGS. 5 through 7 are diagrams illustrating edge dimming control for a non-updated region of an image frame.

FIGS. 8 and 9 are diagrams illustrating edge dimming control according to the panel type of a display device.

FIG. 10 is a diagram illustrating an edge dimming control process based on first coordinate information for an updated region of an image frame.

FIG. 11 is a diagram illustrating an edge dimming control process based on dimming region identification information for a non-updated region of an image frame.

FIG. 12 is a diagram illustrating an active edge dimming control process for an updated region of an image frame.

FIG. 13 is a diagram illustrating an edge dimming control process based on second coordinate information for an updated region of an image frame.

FIG. 14 is a diagram illustrating an edge dimming control process based on the second coordinate information of FIG. 13 and a passive dimming rate.

FIGS. 15 to 17 are diagrams illustrating an edge dimming control process based on the second coordinate information of FIG. 13 and an active dimming rate.

FIG. 18 is a flowchart for explaining an edge dimming control method according to one embodiment of the present disclosure.

FIG. 19 is a diagram for explaining a display device that performs edge dimming control according to one embodiment of the present disclosure.

### BEST MODEL

Hereinafter, embodiments disclosed in this specification will be described in detail with reference to the attached drawings. Regardless of the drawing numbers, identical or similar components will be assigned the same reference numerals, and redundant descriptions thereof will be omitted. The suffixes “module” and “part” used in the following description for components are assigned or used interchangeably solely for the convenience of writing the specification, and do not in themselves have distinct meanings or roles. Furthermore, when describing embodiments disclosed in this specification, detailed descriptions of related known technologies will be omitted if they are deemed to obscure the gist of the embodiments disclosed in this specification. Furthermore, the attached drawings are intended solely to facilitate understanding of the embodiments disclosed in this specification, and the technical concepts disclosed in this specification are not limited by the attached drawings. It should be understood that the drawings encompass all modifications, equivalents, and alternatives included within the spirit and technical scope of the present disclosure.

Terms including ordinal numbers, such as “first,” “second,” etc., may be used to describe various components, but the components are not limited by these terms. These terms are used solely to distinguish one component from another.

When a component is referred to as being “connected” or “connected” to another component, it should be understood that it may be directly connected or connected to that other component, but there may also be other components present in between. Conversely, when a component is referred to as being “directly connected” or “directly connected” to another component, it should be understood that there are no other components present in between.

An edge dimming of the present disclosure can refer to dimming that adjusts brightness with respect to a non-updated region, which is a screen region in which little or no changes in image information occurs in an edge area of an updated region where a large change in image information occurs in an image frame.

That is, the edge dimming of the present disclosure can refer to reducing brightness in the non-updated region that is located around the updated region within an image frame.

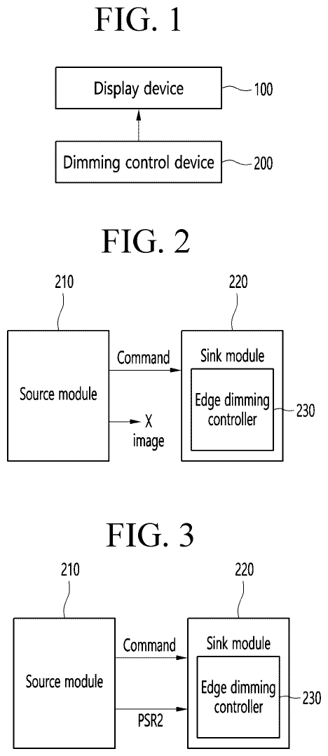

FIG. 1 is a diagram illustrating a dimming control system according to one embodiment of the present disclosure.

As shown in FIG. 1, the dimming control system of the present disclosure can include a display device 100 for displaying an image, and a dimming control device 200 for controlling dimming of the display device 100.

The display device 100 can include both stationary devices such as a personal computer (PC), a network TV, a hybrid broadcast broadband TV (HBBTV), a smart TV, and an Internet protocol TV (IPTV), and mobile devices (or handheld devices) such as a smart phone, a tablet PC, a notebook, and a personal digital assistant (PDA).

Here, a display module of the display device 100 can include a liquid crystal display (LCD), a thin film transistor-liquid crystal display (TFT LCD), an organic light-emitting diode (OLED), a flexible display, a three-dimensional (3D) display, and the like.

Some of the display modules can be configured in a transparent or light-transmitting type, allowing an external view therethrough.

Such display modules can be referred to as transparent display modules, with a representative example being a transparent OLED (TOLED).

Next, the dimming control device 200 can be integrally designed to be combined with the display device 100 or alternatively designed apart from the display device 100.

Here, the dimming control device 200 can include a source module for providing a dimming command for an image frame, and a sink module for controlling dimming of the display device 100 based on the dimming command.

In one example, the source module of the dimming control device 200 can be configured with one or more cores, and can include processors for analyzing image data such as a central processing unit (CPU), a graphics processing unit (GPU), a system on chip (SoC), or an application processor (AP) of a computing device.

In addition, the sink module of the dimming control device 200 can include controllers for dimming control of the display device, such as a timing controller (TCON), a driver-integrated Circuit (D-IC), and a scaler.

When a dimming command is input from the source module, the sink module can obtain an updated region and a non-updated region from an image frame based on the dimming command, determine whether the non-updated region is identified, calculate a dimming weight for the non-updated region when the non-updated region is identified, and control dimming of the display device 100 such that edge dimming is applied to the non-updated region of the image frame based on the calculated dimming weight.

As such, the present disclosure can reduce power consumption and provide natural images to a user by actively or passively controlling edge dimming of the non-updated region in the image frame based on image information.

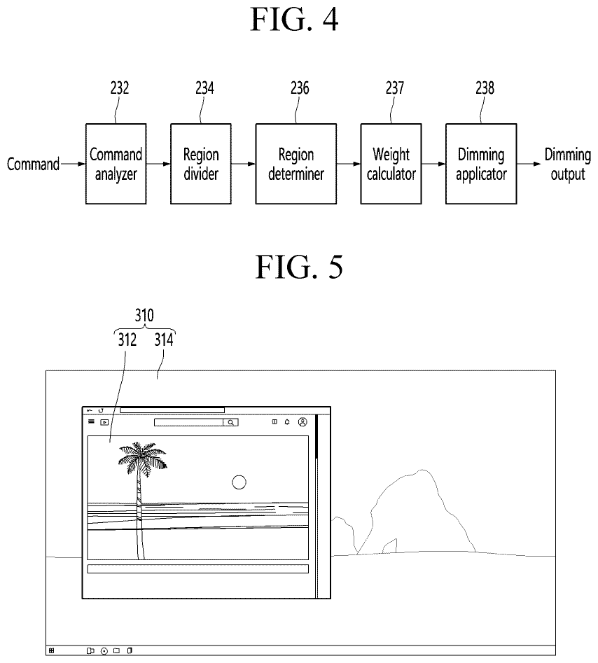

FIGS. 2 and 3 are diagrams illustrating an edge dimming control device according to an embodiment of the present disclosure.

As shown in FIGS. 2 and 3, the edge dimming control device of the present disclosure can include a source module 210 for providing a dimming command for an image frame, and a sink module 220 for controlling dimming of the display device based on the dimming command.

Here, the source module 210 can be configured with one or more cores, and can include processors for analyzing image data such as a central processing unit (CPU), a graphics processing unit (GPU), a system on chip (SoC), or an application processor (AP) of a computing device.

In one embodiment, as shown in FIG. 2, the source module 210 can determine whether updated image content exists in an image frame in which an amount of change in image data is greater than or equal to a reference value, and, when updated image content is not present in the image frame, can recognize the image frame as a still image and provide only a dimming command excluding image frame data.

Here, the source module 210 can provide a dimming command including dimming location information.

In one embodiment, the dimming location information can include the entire region of the image frame in which updated image content is not present.

That is, when a PSR (Panel Self Refresh) function is supported, the source module 210 can provide a dimming command including a PSR (Panel Self Refresh) mode switching control signal for controlling a frame buffer of the sink module 220 to output pre-stored image frame to the display device.

In some cases, the source module 210 can provide a dimming command further including at least one of dimming weight information and dimming time information.

Here, the dimming weight information and the dimming time information can be set to at least one of preset default values and input values provided by a user.

In one embodiment, the dimming weight information can include a single dimming weight value for maintaining the same weight during a dimming time included in the dimming time information, or can include a plurality of dimming weight values in which the dimming weight varies during the dimming time.

In addition, the dimming time information can include the number of image frames in which dimming is continuously performed.

When checking whether the updated image content is present, the source module 210 can use at least one method selected from a CRC (cyclic redundancy check) check method, a frame buffer address check method, and a full-data check method, although the present disclosure is not limited thereto.

Here, the CRC check method can determine the presence or absence of updated image content by calculating a CRC of image data to be displayed and using the calculated CRC. The frame buffer address check method can determine the presence or absence of updated image content depending on whether a write operation of the frame buffer is executed. The full-data check method can determine the presence or absence of updated image content by comparing image data to be displayed on a pixel-by-pixel basis.

In addition, as shown in FIG. 2, the sink module 220 can include an edge dimming controller 230 for controlling dimming of the display device based on a dimming command.

The sink module 220 can include controllers for dimming control of the display device, such as a timing controller (TCON), a driver-integrated Circuit (D-IC), or a scaler.

When only a dimming command excluding image frame data is input, the sink module 220 can extract dimming location information from the dimming command, determine the entire region of the image frame where updated image content is not present as a dimming application region based on the dimming location information, output pre-stored image frame data from a frame buffer to the display device, and control dimming of the display device such that dimming is applied to the entire region of the image frame displayed on the display device.

Here, when the PSR (Panel Self Refresh) function is supported, the sink module 220 can perform a PSR mode for outputting pre-stored image frame data in the frame buffer to the display device according to a PSR mode switching control signal included in the dimming command.

In addition, when dimming weight information is extracted from the dimming command, the sink module 220 can control dimming of the display device such that dimming with the dimming weight value corresponding to the dimming weight information is applied with the same weight to the entire region of the image frame displayed on the display device.

In addition, when dimming time information is extracted from the dimming command, the sink module 220 can control dimming of the display device such that dimming is applied to the entire region of the image frame displayed on the display device during the dimming time corresponding to the dimming time information.

In addition, when both dimming weight information and dimming time information are extracted from the dimming command, the sink module 220 can control dimming of the display device such that dimming is applied to the entire region of the image frame displayed on the display device with a dimming weight value corresponding to the dimming weight information during the dimming time corresponding to the dimming time information.

Here, when the dimming weight information includes a single dimming weight value for maintaining the same dimming weight during a dimming time included in the dimming time information, the sink module 220 can control dimming of the display device such that dimming with the same weight is applied to the entire region of the image frame displayed on the display device with the single dimming weight value during the dimming time.

In some cases, when the dimming weight information includes a plurality of dimming weight values in which the dimming weight varies for each dimming time, the sink module 220 can control dimming of the display device such that dimming with varying dimming weight is applied to the entire region of the image frame displayed on the display device with the plurality of dimming weight values during the dimming time.

In another embodiment, as shown in FIG. 3, the source module 210 can determine whether updated image content, in which a variation amount of image data from the image frame is greater than or equal to a reference value, is present. When updated image content is present in the image frame, the source module 210 can further determine whether updated image content is present in a partial region of the image frame. When updated image content is present in a partial region of the image frame, the source module 210 can provide image frame data including the updated image content together with a dimming command.

Here, the source module 210 can provide a dimming command including update region information in which the updated image content is located in the image frame.

In one embodiment, the update region information can include at least one of a vertical coordinate and a horizontal coordinate of a region in which the updated image content is located.

That is, when the PSR 2 (Panel Self Refresh 2) function is supported, the source module 210 can provide a dimming command including a PSR 2 (Panel Self Refresh 2) mode switching control signal for controlling to selectively update only the update region where the update image content is located among the image frames, and to output the updated region to the display device.

In addition, the source module 210 can provide a dimming command further including at least one of dimming weight information, dimming time information, and dimming region identification information.

Here, the dimming weight information, dimming time information, and dimming region identification information can be set to at least one of a preset default value and an input value input by the user.

In one embodiment, the dimming weight information can include a single dimming weight value that maintains the same dimming weight during a dimming time included in the dimming time information.

In another embodiment, the dimming weight information can include a plurality of dimming weight values in which the dimming weight varies during the dimming time included in the dimming time information.

In addition, the dimming time information can include the number of image frames in which dimming is continuously performed.

Subsequently, the dimming region identification information can include information for the number of divisions of non-updated regions excluding the updated region where the updated image content is located, and for determining whether dimming is to be applied to each non-updated region divided according to the number of divisions.

In one embodiment, when the dimming region identification information includes information for determining dimming of a plurality of divided non-updated regions, the source module 210 can provide dimming weight information including a single dimming weight value such that the plurality of non-updated regions have the same dimming weight.

In another embodiment, when the dimming region identification information includes information for determining dimming of a plurality of divided non-updated regions, the source module 210 can provide dimming weight information including a plurality of dimming weight values such that each of the non-updated regions has a different dimming weight.

In addition, when checking whether the updated image content exists in a partial region of the image frame, the source module 210 cannot provide a dimming command in case the updated image content exists in an entire region of the image frame.

And, as shown in FIG. 3, when a dimming command is input, the sink module 220 can extract update region information where the updated image content is located from the dimming command, and obtain the updated region and non-updated region among the image frames based on the extracted update region information.

Here, when the PSR 2 (Panel Self Refresh 2) function is supported, the sink module 220 can perform a PSR 2 mode that selectively updates only the update region where the updated image content is located among the image frames according to a PSR 2 mode switching control signal included in the dimming command and outputs the updated region to the display device.

In one embodiment, when the update region information includes both vertical coordinates and horizontal coordinates of the region where the update image content is located, the sink module 220 calculates the upper length of the non-updated region located above the update region and the lower length of the non-updated region located below the update region based on the vertical coordinates to identify between the upper non-updated region and the lower non-updated region, and calculates the right length of the non-updated region located to the right of the update region and the left length of the non-updated region located to the left of the update region based on the horizontal coordinates to identify between the right non-updated region and the left non-updated region.

Here, the sink module 220 can control dimming of the display device such that, when dimming weight information including a dimming weight value corresponding to a non-updated region is extracted from the dimming command, the dimming is simultaneously applied to the upper non-updated region, the lower non-updated region, the right non-updated region, and the left non-updated region among the image frames displayed on the display device based on the dimming weight value.

At this time, the sink module 220, when applying dimming to the non-updated region, can apply dimming to the non-updated region such that the dimming weight gradually increases toward the edge of the image frame.

In addition, when the dimming time information is extracted from the dimming command, the sink module 220 can control dimming of the display device such that dimming is applied to the upper non-updated region, the lower non-updated region, the right non-updated region, and the left non-updated region among the image frames displayed on the display device during the dimming time corresponding to the dimming time information.

In another embodiment, when the dimming region identification information is extracted from the dimming command, the sink module 220 can obtain, from the dimming region identification information, the number of divisions of the remaining non-updated regions excluding the update region where the updated image content is located, and information for determining dimming on/off of each non-updated region divided according to the number of divisions, divide the non-updated region into a plurality of divided regions based on the number of divisions of the non-updated region, and determine dimming on/off for each divided region based on the information for determining dimming on/off.

Here, the sink module 220 can control dimming of the display device such that, after dimming on/off is determined for each divided region among the non-updated regions, the dimming weight information including a dimming weight value corresponding to each divided region is extracted from the dimming command, dimming is simultaneously applied to the divided regions determined to be dimming on among the image frames displayed on the display device based on the dimming weight values.

At this time, the sink module 220 can apply dimming to the divided regions such that the dimming weight gradually increases toward the edge of the image frame when applying dimming to the divided regions.

In addition, the sink module 220 can control dimming of the display device such that, after dimming on/off is determined for each divided region among the non-updated regions, dimming is applied to the divided regions determined to be dimming on among the image frames displayed on the display device during a dimming time corresponding to the dimming time information.

In another embodiment, when the dimming region identification information is not extracted from the dimming command, the sink module 220 can obtain the coordinates of the region where the updated image content is located to confirm the location of the updated region, and can autonomously divide and identify the non-updated region into a plurality of divided regions based on the location of the updated region.

In another embodiment, when the update region information includes only the vertical coordinates of the region where the updated image content is located, the sink module 220 can calculate the upper length of the non-updated region located above the updated region and the lower length of the non-updated region located below the updated region based on the vertical coordinates to identify the upper non-updated region and the lower non-updated region.

Here, the sink module 220 can generate a new dimming weight value to be applied to the upper non-updated region and the lower non-updated region based on the luminance value of the updated region when the dimming weight information is not extracted from the dimming command, and can control dimming of the display device such that dimming is simultaneously applied to the upper non-updated region and the lower non-updated region among the image frames displayed on the display device based on the new dimming weight value.

At this time, the sink module 220 can apply dimming to the non-updated region such that the dimming weight gradually increases toward the edge of the image frame when applying dimming to the non-updated region.

In some cases, the sink module 220 can control dimming of the display device such that dimming is simultaneously applied to the upper non-updated region and the lower non-updated region among the image frames displayed on the display device based on the dimming weight values when the dimming weight information including dimming weight values corresponding to the upper non-updated region and the lower non-updated region is extracted from the dimming command.

At this time, the sink module 220 can apply dimming to the non-updated region such that the dimming weight gradually increases toward the edge of the image frame when applying dimming to the non-updated region.

As another embodiment, when the dimming weight information including dimming weight values corresponding to an upper non-updated region and a lower non-updated region is extracted from a dimming command, the sink module 220 calculates a change amount between a current frame and a previous frame, checks whether the calculated change amount is less than a threshold value, and when the change amount is less than the threshold value, selects a left non-updated region located to the left of the updated region and a right non-updated region located to the right of the updated region as dimming areas, and determines dimming weight values for the left non-updated region and the right non-updated region based on the calculated change amount.

Here, the sink module 220 controls the dimming of the display device such that dimming is simultaneously applied to the upper non-updated region and the lower non-updated region among the image frames displayed on the display device based on the dimming weight value included in the dimming weight information, and controls the dimming of the display device such that dimming is simultaneously applied to the left non-updated region and the right non-updated region among the image frames displayed on the display device based on the dimming weight value determined corresponding to the calculated amount of change.

In this way, the present disclosure, through various embodiments, can reduce power consumption and provide a natural image to the user by actively or passively controlling edge dimming for the non-updated region among the image frames based on image information.

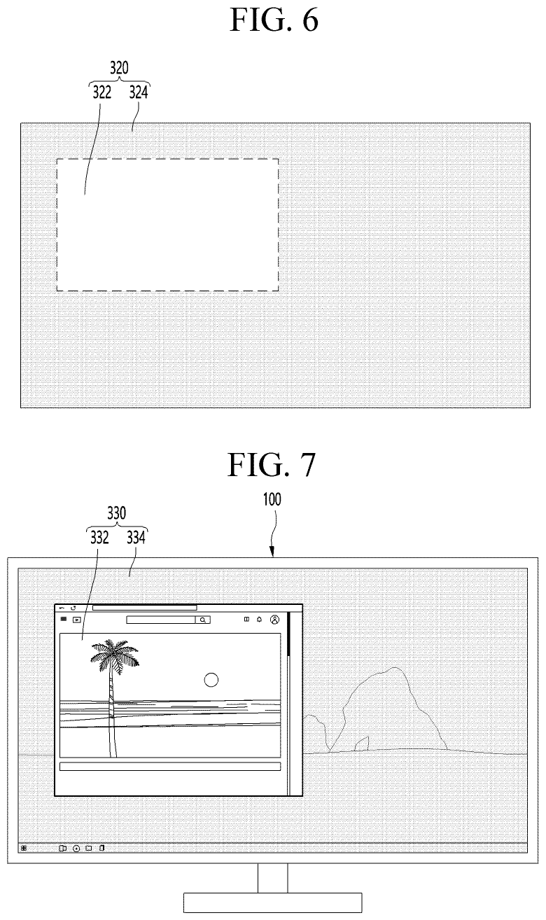

FIG. 4 is a diagram illustrating a sink module of an edge dimming control device according to an embodiment of the present disclosure.

As illustrated in FIG. 4, the sink module of the present disclosure can include an edge dimming controller 230 that controls dimming of a display device based on a dimming command.

The edge dimming controller 230 can include a command analyzer 232, a region divider 234, a region determiner 236, a weight calculator 237, and a dimming applicator 238.

The command analyzer 232 can analyze a dimming command when a dimming command is input.

Here, the dimming command can include update region information where updated image content is located within an image frame.

For example, the update region information can include at least one of the vertical coordinate and horizontal coordinate of the region where the updated image content is located.

Additionally, the dimming command can further include at least one of dimming weight information, dimming time information, and dimming region identification information.

For example, the dimming weight information can include a single dimming weight value that maintains the dimming weight constant during the dimming time included in the dimming time information.

For another example, the dimming weight information can include a plurality of dimming weight values that vary the dimming weight during the dimming time included in the dimming time information.

The dimming time information can include the number of image frames during which dimming is continuously performed.

The dimming region identification information can include the number of divisions of non-updated regions, excluding the updated region where the updated image content is located, and information for determining whether to dim each non-updated region corresponding to the number of divisions.

Furthermore, the region divider 234 can obtain updated and non-updated regions from the image frame based on the analyzed dimming command, and can divide and identify the non-updated region into a plurality of divided regions.

Here, the region divider 234 can autonomously divide and identify a non-updated region into a plurality of divided regions based on the location of the updated region.

In some cases, the region divider 234 can passively divide and identify the non-updated region into a plurality of divided regions based on the dimming region identification information included in the dimming command.

Next, the region determiner 236 can determine a divided region to be dimmed among the plurality of divided regions.

Here, the region determiner 236 can select, as the divided region to be dimmed, a divided region in which a change in image information is small or a divided region in which there is no change in image information among the non-updated regions.

Subsequently, the weight calculator 237 can calculate a dimming weight to be applied to the divided region to be dimmed.

Here, the weight calculator 237 can calculate a dimming weight to be applied to the divided region to be dimmed based on a current power consumption.

Further, the dimming applicator 238 can control dimming of the display device such that edge dimming is applied to the non-updated region of the image frame based on the calculated dimming weight.

Here, the dimming applicator 238 can simultaneously apply dimming to the divided regions of the non-updated region with the same weight value.

In this case, when dimming is applied to the divided regions of the non-updated region with the same weight value, the dimming applicator 238 can apply dimming to the non-updated region such that the dimming weight gradually increases toward an edge direction of the image frame.

In addition, the dimming applicator 238 can simultaneously apply dimming with different weight values to the divided regions of the non-updated region.

At this time, when applying dimming with different weight values to the divided regions of the non-updated region, the dimming applicator 238 can apply dimming to the non-updated region such that the dimming weight gradually increases toward the edge of the image frame.

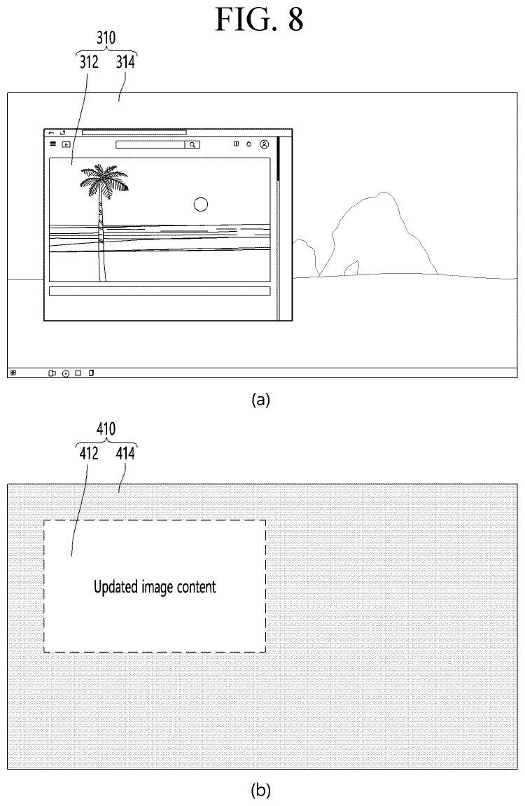

FIGS. 5 to 7 are diagrams for explaining edge dimming control for a non-updated region of an image frame.

As illustrated in FIG. 5, the present disclosure checks whether there is an update region 312 in which updated image content is located, in which the amount of change in image data is greater than or equal to a reference value, and a non-updated region 314 in which the amount of change in image data is less than the reference value, checks whether the update region 312 exists in a portion of the image frame 310, and when the update region 312 exists in a portion of the image frame 310, generates and provides a dimming command including update region information.

Next, as illustrated in FIG. 6, the present disclosure can extract update region information where updated image content is located from a dimming command, and perform dimming control based on the extracted update region information to maintain the brightness of an update region 322 among the display area 320 where the image is displayed, and reduce the brightness of a non-updated region 324.

Next, as illustrated in FIG. 7, the present disclosure can control dimming of the display device 100 so as to maintain the brightness of an update region 332 among the display screen 330 of the display device 100 where updated image content is located, and reduce the brightness of a non-updated region 334 where the amount of change in image data is less than a reference value.

Here, the present disclosure can control dimming of the display device 100 by adjusting at least one of pixel data of the display panel and luminance data of the backlight based on the panel type of the display device 100.

That is, the present disclosure can control dimming of the display device 100 by checking the panel type of the display device 100 and adjusting the luminance data of the backlight such that edge dimming is applied to a non-updated region of an image frame when a backlight is present.

In addition, the present disclosure can control dimming of the display device 100 by checking the panel type of the display device 100 and adjusting the pixel data of the display panel such that edge dimming is applied to a non-updated region of an image frame when a backlight is present.

In some cases, the present disclosure can control the first dimming of the display device 100 by obtaining the current power consumption from the display device 100, and when the obtained current power consumption is equal to or greater than a first preset reference consumption, checking whether a backlight of the display device 100 is present, and when a backlight is present, adjusting the luminance data of the backlight such that the first edge dimming is applied to a non-updated region of the image frame, and controlling the second dimming of the display device 100 by obtaining the current power consumption from the display device 100 after the first dimming of the display device 100, and when the obtained current power consumption is equal to or greater than a second preset reference consumption, adjusting the pixel data of the display panel such that the second edge dimming is applied to a non-updated region of the image frame.

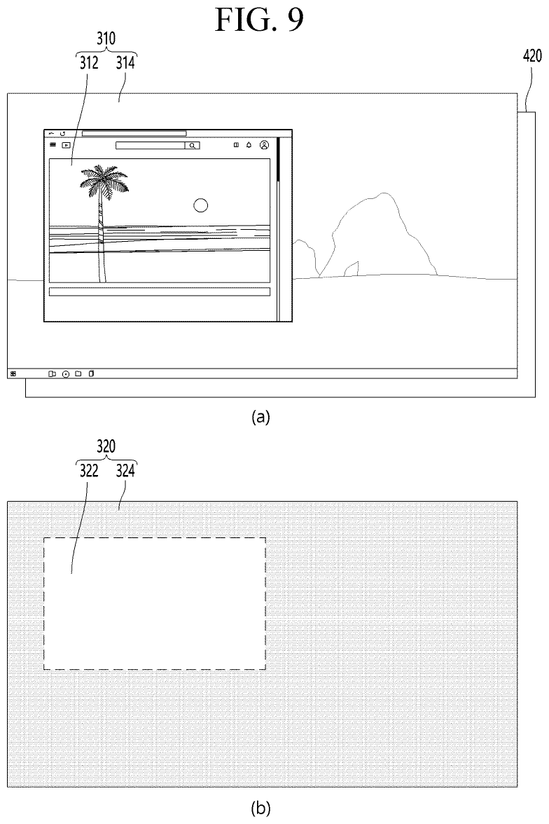

FIGS. 8 and 9 are diagrams for illustrating edge dimming control according to the panel type of a display device.

As shown in FIG. 8(a) and (b), the present disclosure can control edge dimming for a non-updated region of an image frame by checking the panel type of the display device and adjusting pixel data of the display panel when a backlight is not present.

For example, when the panel type of the display device is an OLED (Organic Light Emitting Diode), as shown in FIG. 8(a), the present disclosure checks whether there is an update region 312 where updated image content is located, in which the amount of change in image data from the image frame 310 is greater than a reference value, and a non-updated region 314 where the amount of change in image data is less than the reference value, and as shown in FIG. 8(b), by adjusting pixel data of the display panel, dimming can be controlled to maintain the brightness of the update region 412 where the updated image content is located among the display screens 410, and reduce the brightness of the non-updated region 414 where the amount of change in image data is less than the reference value.

As shown in FIG. 9(a) and (b), the present disclosure can control edge dimming for a non-updated region of an image frame by checking the panel type of the display device and adjusting the luminance data of a backlight 420 of the display panel when the backlight 420 is present.

For example, when the panel type of the display device is an LED (Light Emitting Diode) backlight, as shown in FIG. 9(a), the present disclosure can check whether there is an update region 312 where updated image content is located, in which the amount of change in image data from the image frame 310 is greater than a reference value, and a non-updated region 314 where the amount of change in image data is less than the reference value, and as shown in FIG. 9(b), dimming can be controlled to maintain the brightness of the update region 322 where updated image content is located among the display area 320 by adjusting the brightness data of the backlight 420, and reduce the brightness of the non-updated region 324 where the amount of change in image data is less than the reference value.

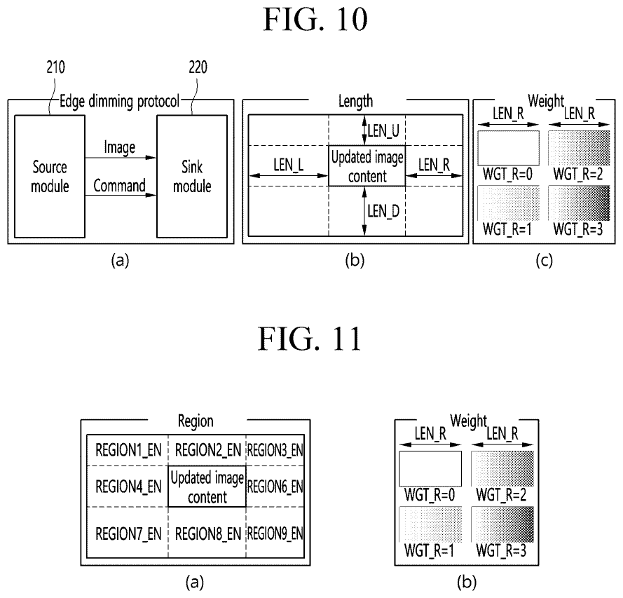

FIG. 10 is a diagram illustrating an edge dimming control process based on first coordinate information for an update region of an image frame.

As illustrated in FIG. 10(a), the source module 210 of the present disclosure can determine whether updated image content exists in an image frame, wherein the amount of change in image data is greater than or equal to a reference value. When the updated image content exists in the image frame, the source module 210 can determine whether the updated image content exists in a portion of the image frame. When the updated image content exists in a portion of the image frame, the source module 210 can provide image frame data including the updated image content and a dimming command.

Here, the source module 210 can provide a dimming command including update region information in which the updated image content is located within the image frame.

For example, as illustrated in FIG. 10(b), the update region information can include at least one of a vertical coordinate and a horizontal coordinate of the region in which the updated image content is located.

That is, when the PSR 2 (Panel Self Refresh 2) function is supported, the source module 210 can provide a dimming command including a PSR 2 (Panel Self Refresh 2) mode switching control signal that controls the display device to selectively update only the update region where the update image content is located among the image frames.

In addition, the source module 210 can provide a dimming command further including at least one of dimming weight information and dimming time information.

Here, the dimming weight information and the dimming time information can be set to at least one of a preset default value and an input value input by the user.

For example, as shown in FIG. 10(c), the dimming weight information can include a single dimming weight value that maintains the dimming weight the same during the dimming time included in the dimming time information.

As another example, as shown in FIG. 10(c), the dimming weight information can include a plurality of dimming weight values for which the dimming weight varies during the dimming time included in the dimming time information.

In addition, the dimming time information can include the number of image frames for which dimming is continuously performed.

Next, the dimming region identification information can include the number of divisions of non-updated regions excluding the updated region where the updated image content is located, and information for determining whether to dim each non-updated region divided according to the number of divisions.

In one embodiment, when the dimming region identification information includes information for determining dimming of a plurality of divided non-updated regions, the source module 210 can provide the dimming weight information including a single dimming weight value such that a plurality of the non-updated regions have the same dimming weight.

In another embodiment, when the dimming region identification information includes information for determining dimming of a plurality of divided non-updated regions, the source module 210 can provide dimming weight information including a plurality of dimming weight values such that each non-updated region has a different dimming weight.

In addition, when checking whether the updated image content exists in a portion of the image frame, the source module 210 cannot provide a dimming command when the updated image content exists in the entire image frame.

In addition, when a dimming command is input, the sink module 220 can extract update region information where the updated image content is located from the dimming command, and obtain updated regions and non-updated regions within the image frame based on the extracted update region information.

Here, the sink module 220 can perform a PSR 2 mode in which, when the PSR 2 (Panel Self Refresh 2) function is supported, only the update region where the update image content is located among the image frames is selectively updated and output to the display device according to the PSR 2 mode switching control signal included in the dimming command.

In one embodiment, when the update region information includes both vertical coordinates and horizontal coordinates of the region where the update image content is located, the sink module 220 calculates an upper length LEN_U of a non-updated region located above the update region based on the vertical coordinates and a lower length LEN_D of a non-updated region located below the update region to identify the upper non-updated region and the lower non-updated region, and calculates a right length LEN-R of a non-updated region located to the right of the update region and a left length LEN_L of a non-updated region located to the left of the update region based on the horizontal coordinates to identify the right non-updated region and the left non-updated region.

Here, the sink module 220 can control dimming of the display device such that, when dimming weight information including a dimming weight value corresponding to a non-updated region is extracted from the dimming command, the dimming is simultaneously applied to the upper non-updated region, the lower non-updated region, the right non-updated region, and the left non-updated region among the image frames displayed on the display device based on the dimming weight value.

For example, as shown in FIG. 10(c), in the case of the right non-updated region having the right length LEN-R, any one of the dimming weight values 0, 1, 2, and 3 can be applied.

When applying dimming to the non-updated region, the sink module 220 can apply dimming to the non-updated region such that the dimming weight gradually increases toward the edge of the image frame.

In addition, the sink module 220 can control dimming of the display device such that, when dimming time information is extracted from the dimming command, dimming is applied to the upper non-updated region, the lower non-updated region, the right non-updated region, and the left non-updated region among the image frames displayed on the display device during the dimming time corresponding to the dimming time information.

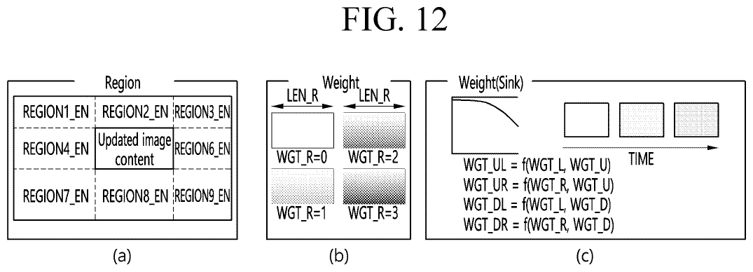

FIG. 11 is a diagram for explaining an edge dimming control process based on dimming region identification information for a non-updated region of an image frame.

The source module of the present disclosure can provide a dimming command including update region information where updated image content is located within the image frame.

In one embodiment, the update region information can include at least one of a vertical coordinate and a horizontal coordinate of the region where the updated image content is located.

Furthermore, the source module can provide a dimming command further including at least one of dimming weight information, dimming time information, and dimming region identification information.

Here, the dimming weight information, dimming time information, and dimming region identification information can be set to at least one of a preset default value and an input value input by a user.

The dimming region identification information can include the number of divisions of non-updated regions other than the updated region where the updated image content is located, and information for determining whether to dim each non-updated region divided according to the number of divisions.

In one embodiment, when the source module includes information for determining dimming of a plurality of non-updated regions divided into a plurality of parts in the dimming region identification information, the source module can provide dimming weight information including a single dimming weight value such that a plurality of the non-updated regions have the same dimming weight.

In another embodiment, when the dimming region identification information includes information for determining dimming of a plurality of non-updated regions divided into a plurality of parts, the source module can provide dimming weight information including a plurality of dimming weight values such that each non-updated region has a different dimming weight.

As shown in FIG. 11(a), when the dimming region identification information is extracted from a dimming command, the sink module of the present disclosure can obtain information for determining the number of divisions of non-updated regions other than the updated region where the updated image content is located from the dimming region identification information and dimming on/off of each non-updated region divided according to the number of divisions, divide the non-updated region into a plurality of divided regions based on the number of divisions of the non-updated region, and determine dimming on/off for each of the divided regions based on the information for determining dimming on/off.

When the number of divisions of the remaining non-updated regions excluding the updated region among the image frames is 8, the sink module can identify the entire region of the image frame into a first divided region REGION1_EN located in the upper left diagonal direction of the updated region, a second divided region REGION2_EN located above the updated region, a third divided region REGION3_EN located in the upper right diagonal direction of the updated region, a fourth divided region REGION4_EN located to the left of the updated region, a fifth divided region REGION5_EN located to the right of the updated region, a seventh divided region REGION7_EN located in the lower left diagonal direction of the updated region, an eighth divided region REGION8_EN located below the updated region, and a ninth divided region REGION9_EN located in the lower right diagonal direction of the updated region.

As shown in FIG. 11(b), after dimming on/off is determined for each divided region among the non-updated regions, the sink module can extract dimming weight information including a dimming weight value corresponding to each divided region from the dimming command, and then control the dimming of the display device such that dimming of the same weight is simultaneously applied to divided regions determined to be dimming on among the image frames displayed on the display device based on the dimming weight value.

Here, when applying dimming of the same weight to divided regions, the sink module can apply dimming to the divided regions such that the dimming weight gradually increases toward the edge of the image frame.

In some cases, the sink module can control dimming of the display device such that, when dimming on/off is determined for each divided region among the non-updated regions, and dimming weight information including a dimming weight value corresponding to each divided region is extracted from the dimming command, dimming of different weights is simultaneously applied to divided regions determined to be dimmed on among the image frames displayed on the display device based on the dimming weight values.

Here, when applying dimming of different weights to the divided regions, the sink module can apply dimming to the divided regions such that the dimming weight gradually increases toward the edge of the image frame.

In addition, the sink module can control dimming of the display device such that, when dimming on/off is determined for each divided region among the non-updated regions, dimming of the divided regions determined to be dimmed on among the image frames displayed on the display device is applied during a dimming time corresponding to the dimming time information, when dimming time information is extracted from the dimming command.

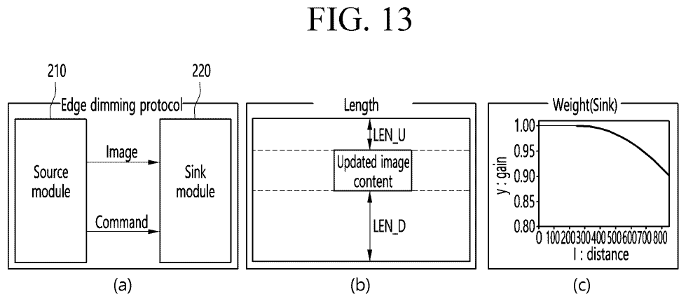

FIG. 12 is a diagram illustrating an active edge dimming control process for an update region of an image frame.

As shown in FIG. 12(a), the sink module of the present disclosure can, when dimming region identification information is not extracted from a dimming command, obtain the coordinates of the region where the updated image content is located, verify the location of the update region, and independently divide the non-updated region into a plurality of divided regions based on the location of the updated region, thereby identifying a plurality of divided regions.

Here, when the non-updated region is divided into a plurality of divided regions, the sink module can identify a second divided region located above the update region, a fourth divided region located to the left of the update region, a sixth divided region located to the right of the update region, and an eighth divided region located below the update region based on coordinate information of the update region, and can identify a first divided region located in the upper left diagonal direction of the update region, a third divided region located in the upper right diagonal direction of the update region, a seventh divided region located in the lower left diagonal direction of the update region, and a ninth divided region located in the lower right diagonal direction of the update region based on the second divided region, the fourth divided region, the sixth divided region, and the eighth divided region.

As shown in FIG. 12(b), when the dimming weight information including dimming weight values corresponding to the second, fourth, sixth, and eighth divided regions is extracted from the dimming command, the sink module can control dimming of the display device such that dimming of the same weight is simultaneously applied to the second, fourth, sixth, and eighth divided regions among the image frames displayed on the display device based on the dimming weight values.

And, as shown in FIG. 12(c), the sink module can generate new dimming weight values to be applied to the first, third, seventh, and ninth divided regions based on the dimming weight values corresponding to the second, fourth, sixth, and eighth divided regions, and can control dimming of the display device such that dimming of the same weight is simultaneously applied to the first, third, seventh, and ninth divided regions among the image frames displayed on the display device based on the new dimming weight values.

In one embodiment, the sink module can generate a new dimming weight value (WGT_UL) to be applied to the first divided region based on the dimming weight values (WGT_L, WGT_U) corresponding to the second and fourth divided regions, generate a new dimming weight value (WGT_UR) to be applied to the third divided region based on the dimming weight values (WGT_R, WGT_U) corresponding to the second and sixth divided regions, generate a new dimming weight value (WGT_DL) to be applied to the seventh divided region based on the dimming weight values (WGT_L, WGT_D) corresponding to the fourth and eighth divided regions, and generate a new dimming weight value (WGT_DR) to be applied to the ninth divided region based on the dimming weight values (WGT_R, WGT_D) corresponding to the sixth and eighth divided regions.

Here, the sink module can apply dimming to the divided regions such that the dimming weight gradually increases toward the edge of the image frame when applying dimming with the same weight to the divided regions.

In some cases, the sink module can control dimming of the display device such that dimming with different weights is simultaneously applied to the second, fourth, sixth, and eighth divided regions among the image frames displayed on the display device based on the dimming weight values when dimming weight information including dimming weight values corresponding to the second, fourth, sixth, and eighth divided regions is extracted from the dimming command, and can generate new dimming weight values to be applied to the first, third, seventh, and ninth divided regions based on the dimming weight values corresponding to the second, fourth, sixth, and eighth divided regions, and can control dimming of the display device such that dimming with different weights is simultaneously applied to the first, third, seventh, and ninth divided regions among the image frames displayed on the display device based on the new dimming weight values.

Here, the sink module can apply dimming to the divided regions such that the dimming weight gradually increases toward the edge of the image frame when applying dimming of different weights to the divided regions.

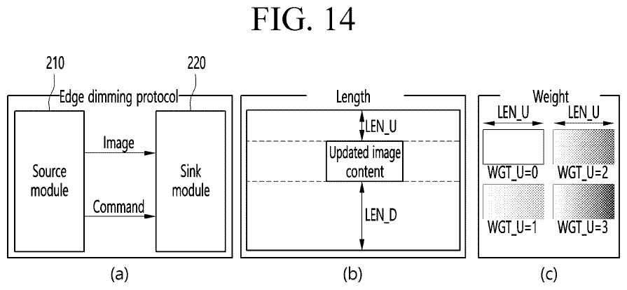

FIG. 13 is a diagram illustrating an edge dimming control process based on second coordinate information for an update region of an image frame.

As shown in FIG. 13(a), the source module 210 of the present disclosure can provide a dimming command including update region information where updated image content is located within the image frame.

Here, the update region information can include only the vertical coordinates of the region where the updated image content is located.

As shown in FIG. 13(b), the sink module 220 of the present disclosure can identify the upper and lower non-updated regions by calculating the upper length LEN_U of the non-updated region located above the updated region and the lower length LEN_D of the non-updated region located below the updated region based on the vertical coordinates, when the update region information includes only the vertical coordinates of the region where the updated image content is located.

As shown in FIG. 13(c), the sink module 220 of the present disclosure can generate a new dimming weight value to be applied to the upper non-updated region and the lower non-updated region based on the luminance value of the updated region when dimming weight information is not extracted from the dimming command, and control the dimming of the display device such that dimming of the same weight is simultaneously applied to the upper non-updated region and the lower non-updated region among the image frames displayed on the display device based on the new dimming weight value.

Here, the sink module 220, when applying dimming of the same weight to the non-updated region, can apply dimming to the non-updated region such that the dimming weight gradually increases toward the edge of the image frame.

In some cases, the sink module 220 can generate a new dimming weight value to be applied to the upper non-updated region and the lower non-updated region based on the luminance value of the updated region when the dimming weight information is not extracted from the dimming command, and can control dimming of the display device such that dimming of different weights is simultaneously applied to the upper non-updated region and the lower non-updated region among the image frames displayed on the display device based on the new dimming weight value.

Here, the sink module 220 can apply dimming to the non-updated region such that the dimming weight gradually increases toward the edge of the image frame when applying dimming of different weights to the non-updated region.

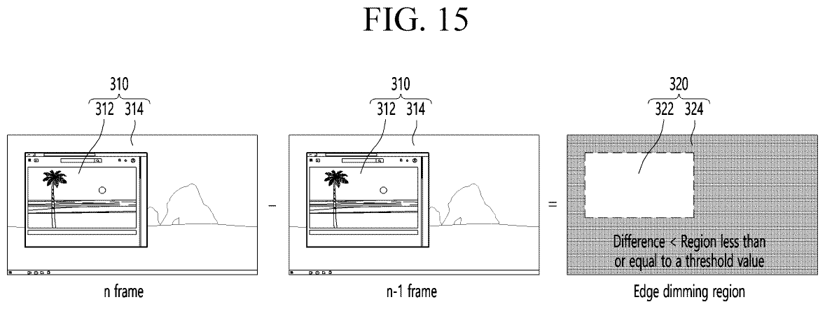

FIG. 14 is a diagram illustrating an edge dimming control process based on the second coordinate information and the passive dimming rate of FIG. 13.

As shown in FIG. 14(a), the source module 210 of the present disclosure can provide a dimming command including update region information where updated image content is located within an image frame.

Here, the update region information can include only the vertical coordinates of the region where the updated image content is located.

As shown in FIG. 14(b), the sink module 220 of the present disclosure can identify the upper non-updated region and the lower non-updated region by calculating the upper length LEN_U of the non-updated region located above the updated region and the lower length LEN_D of the non-updated region located below the updated region based on the vertical coordinates when the update region information includes only the vertical coordinates of the region where the updated image content is located.

As shown in FIG. 14(c), when dimming weight information including dimming weight values corresponding to the upper non-updated region and the lower non-updated region is extracted from the dimming command, the sink module 220 of the present disclosure can control dimming of the display device such that dimming of the same weight is simultaneously applied to the upper non-updated region and the lower non-updated region among the image frames displayed on the display device based on the dimming weight values.

Here, when applying dimming of the same weight to the non-updated region, the sink module 220 can apply dimming to the non-updated region such that the dimming weight gradually increases toward the edge of the image frame.

In some cases, when the sink module 220 of the present disclosure extracts dimming weight information including dimming weight values corresponding to the upper non-updated region and the lower non-updated region from the dimming command, the sink module 220 can control dimming of the display device such that dimming of different weights is simultaneously applied to the upper non-updated region and the lower non-updated region among the image frames displayed on the display device based on the dimming weight values.

Here, when applying dimming of different weights to the non-updated region, the sink module 220 can apply dimming to the non-updated region such that the dimming weight gradually increases toward the edge of the image frame.

In addition, the sink module 220 of the present disclosure can control dimming of the display device such that dimming is applied to the upper non-updated region and the lower non-updated region among the image frames displayed on the display device during the dimming time corresponding to the dimming time information when dimming time information is extracted from the dimming command.

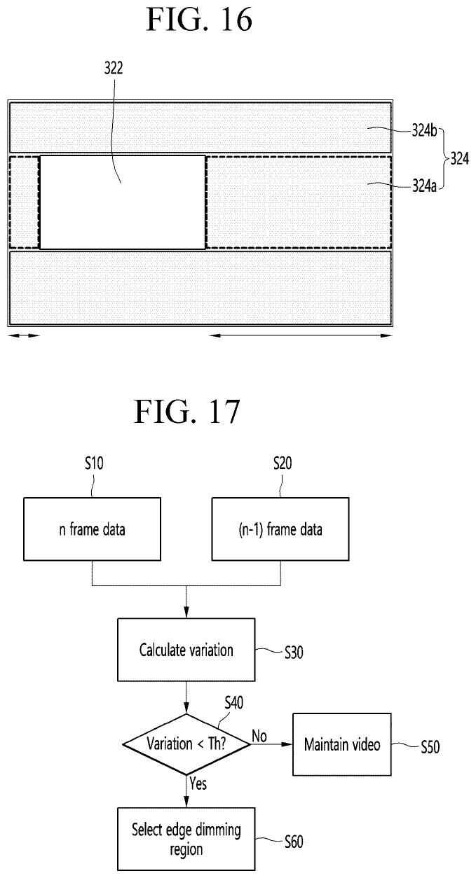

FIGS. 15 to 17 are diagrams illustrating an edge dimming control process based on the second coordinate information and the active dimming rate of FIG. 13.

As shown in FIGS. 15 to 17, the present disclosure can select an edge dimming area by calculating a change amount between a current frame and a previous frame and confirming whether the calculated change amount is less than a threshold value.

As shown in FIG. 15, in the present disclosure, when an updated region 312 in which updated image content having a variation in image data greater than or equal to a reference value is located in an image frame 10 and a non-updated region 314 in which the variation in image data is less than or equal to a reference value is included, the variation between the nth image frame and the n-1th image frame can be calculated, and a region in the display region 320 in which the calculated variation (difference) is less than a threshold value can be selected as a non-updated region 324, and a region in the display region 320 in which the calculated variation (difference) is greater than or equal to a threshold value can be selected as an updated region 322.

As shown in FIG. 17, the present disclosure can obtain the nth image frame and the n-1th image frame (S10, S20), and calculate the variation between the nth image frame and the n-1th image frame (S30).

In addition, the present disclosure can determine whether the calculated change amount is less than a threshold value (S40).

Next, the present disclosure can maintain the brightness of the image when the change amount is greater than or equal to the threshold value (S50), and can select an update region where the change amount is less than the threshold value as an edge dimming region (S60).

As shown in FIG. 16, when the dimming weight information including dimming weight values corresponding to an upper non-updated region and a lower non-updated region is extracted from a dimming command, the present disclosure can passively apply dimming to an non-updated region 324b located above and below an updated region 322 among image frames displayed on a display device based on the dimming weight values included in the dimming weight information, and can actively apply dimming to an non-updated region 324a located to the left and right of an updated region 322 among image frames displayed on a display device based on the dimming weight values determined corresponding to the calculated amount of change.

In this way, the present disclosure can calculate a change amount between a current frame and a previous frame when dimming weight information including dimming weight values corresponding to an upper non-updated region and a lower non-updated region is extracted from a dimming command, check whether the calculated change amount is less than a threshold value, and when the change amount is less than the threshold value, select a left non-updated region located to the left of an updated region and a right non-updated region located to the right of the updated region as dimming areas, and determine dimming weight values for the left non-updated region and the right non-updated region based on the calculated change amount.

That is, the present disclosure can control the dimming of the display device such that dimming of the same weight is simultaneously applied to an upper non-updated region and a lower non-updated region among image frames displayed on the display device based on a dimming weight value included in dimming weight information, and control the dimming of the display device such that dimming of the same weight is simultaneously applied to a left non-updated region and a right non-updated region among image frames displayed on the display device based on a dimming weight value determined corresponding to a calculated amount of change.

Here, the present disclosure can apply dimming to the non-updated region such that the dimming weight gradually increases toward the edge of the image frame when applying dimming of the same weight to the non-updated region.

In some cases, the present disclosure can control dimming of the display device such that dimming of different weights is simultaneously applied to an upper non-updated region and a lower non-updated region among image frames displayed on the display device based on a dimming weight value included in dimming weight information, and can control dimming of the display device such that dimming of different weights is simultaneously applied to a left non-updated region and a right non-updated region among image frames displayed on the display device based on a dimming weight value determined corresponding to a calculated amount of change.

Here, the present disclosure can apply dimming to the non-updated region such that the dimming weight gradually increases toward the edge of the image frame when applying dimming of different weights to the non-updated region.

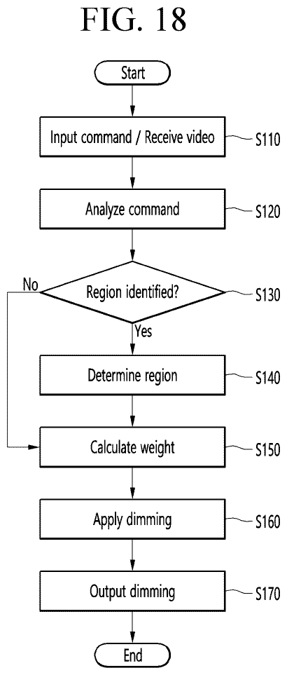

FIG. 18 is a flowchart illustrating an edge dimming control method according to an embodiment of the present disclosure.

As shown in FIG. 18, the present disclosure can receive an image frame and a dimming command (S110).

Furthermore, the present disclosure can analyze the input dimming command (S120).

Here, the dimming command can include update region information where updated image content is located within the image frame.

As an example, the update region information can include at least one of a vertical coordinate and a horizontal coordinate of the region where the updated image content is located.

Additionally, the dimming command can further include at least one of dimming weight information, dimming time information, and dimming region identification information.

In one embodiment, the dimming weight information can include a single dimming weight value that maintains the dimming weight constant during the dimming time included in the dimming time information.

In another embodiment, the dimming weight information can include a plurality of dimming weight values for which the dimming weight varies during the dimming time included in the dimming time information.

The dimming time information can include the number of image frames on which dimming is continuously performed.

The dimming region identification information can include the number of divisions of non-updated regions excluding the updated region where the updated image content is located, and information for determining whether each of the non-updated region is dimmed corresponding to the number of divisions.

Next, the present disclosure can obtain updated regions and non-updated regions among image frames based on a dimming command, and determine whether the non-updated region is divided and identified into a plurality of divided regions (S130).

Here, the present disclosure can actively divide and identify non-updated regions, based on the location of the updated region, into a plurality of divided regions.

In some cases, the present disclosure can manually divide the region into a plurality of divided regions based on dimming region identification information included in the dimming command.

Next, the present disclosure can determine a divided region to be dimmed among the plurality of divided regions once the non-updated region has been divided into a plurality of divided regions (S140).

Here, the present disclosure can select a divided region with little or no change in image information among the non-updated regions as the divided region to be dimmed.

Furthermore, the present disclosure can calculate a dimming weight to be applied to the divided region to be dimmed (S150).

Here, the present disclosure can calculate a dimming weight to be applied to the divided region to be dimmed based on the current power consumption.

Next, the present disclosure can apply edge dimming to a non-updated region of an image frame based on the calculated dimming weight (S160).

Here, the present disclosure can simultaneously apply dimming with the same weight value to the divided regions of the non-updated region.

At this time, the present disclosure can apply dimming to the non-updated region such that the dimming weight gradually increases toward the edge of the image frame when applying dimming with the same weight value to the divided regions of the non-updated region.

Furthermore, the present disclosure can simultaneously apply dimming with different weight values to the divided regions of the non-updated region.

At this time, the present disclosure can apply dimming to the non-updated region such that the dimming weight gradually increases toward the edge of the image frame when applying dimming with different weight values to the divided regions of the non-updated region.

Subsequently, the present disclosure can control dimming of the display device such that the applied edge dimming is output (S170).

In this way, the present disclosure can reduce power consumption and provide a natural image to the user by actively or passively controlling edge dimming for the non-updated region of the image frame based on image information.

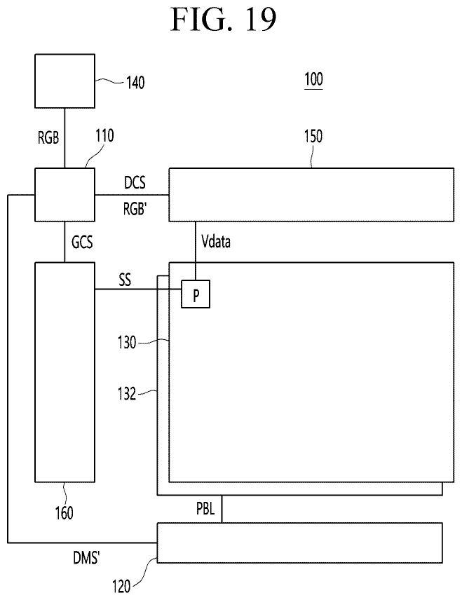

FIG. 19 is a diagram illustrating a display device performing edge dimming control according to an embodiment of the present disclosure.

As shown in FIG. 19, the display device 100 can include a host 140, an image data processing device 110, a data driving device 150, a gate driving device 160, a display panel 130, a backlight driving device 120, etc.

Here, the host 140 can include a source device that provides a dimming command for an image frame.

The source device can determine whether there is updated image content in which the amount of change in image data from the image frame is greater than a reference value, and when there is no updated image content in the image frame, the source device can recognize the image frame as a still image and provide only a dimming command excluding the image frame data.

The source device can provide a dimming command including dimming location information, wherein the dimming location information can include the entire region of the image frame where updated image content does not exist.

That is, when the PSR (Panel Self Refresh) function is supported, the source device can provide a dimming command including a PSR (Panel Self Refresh) mode switching control signal that controls image frame data pre-stored in a frame buffer to be output to the display device.

In some cases, the source device can provide a dimming command further including at least one of dimming weight information and dimming time information.

In addition, the image data processing device 110 can be a sink device that controls dimming of the display device 100 based on the dimming command.

Here, when a dimming command is input, the sink device obtains an updated region and a non-updated region among the image frames based on the dimming command, checks whether the non-updated region is identified, calculates a dimming weight for the non-updated region when the non-updated region is identified, and controls the dimming of the display device 100 such that edge dimming is applied to the non-updated region of the image frame based on the calculated dimming weight.

The image data (RGB) generated by the host 140 is converted by the image data processing device 110, and the converted image data (RGB') is transmitted to the data driving device 150.

The dimming control signal generated by the image data processing device 110 is transmitted to the backlight driving device 120 to adjust the brightness data of the backlight 132.

Here, the image data processing device 110 can transmit the dimming control signal to the data driving device 150 to adjust the pixel data of the display panel 130 when the backlight 132 is absent.

The display panel 130 can have a plurality of pixels (P) arranged, and data lines and gate lines connected to the plurality of pixels can be arranged.

The gate driving device 160 can transmit a scan signal (SS) to the gate lines to connect each pixel to the data lines, and the data driving device 150 can supply a data voltage (Vdata) corresponding to image data to the data lines to drive each pixel (P).

The image data processing device 110 can control the driving timing for each pixel (P) by transmitting a gate control signal (GCS) to the gate driving device 160 and a data control signal (DCS) to the data driving device 150.

The gate driving device 160 can be referred to as a gate driver (GDIC), the data driving device 150 can be referred to as a source driver (SDIC), and the image data processing device 110 can be referred to as a timing controller (TCON).

The display panel 130 can have a backlight 132 disposed thereon, and the backlight 132 can be driven by the backlight driving device 120.

The backlight driving device 120 can control the brightness of the light sources constituting the backlight 132.

Here, the backlight driving device 120 can control dimming of the backlight 132 based on the received dimming control signal.

Meanwhile, when a dimming command is input, the image data processing device 110 extracts update region information where the updated image content is located from the dimming command, obtains updated regions and non-updated regions among the image frames based on the extracted update region information, and applies a dimming weight to the non-updated regions among the image frames displayed on the display device based on the dimming weight information.

In one embodiment, when the update region information includes both vertical coordinates and horizontal coordinates of the region where the updated image content is located, the image data processing device 110 calculates the upper length of the non-updated region located above the updated region and the lower length of the non-updated region located below the updated region based on the vertical coordinates to identify between the upper non-updated region and the lower non-updated region, and calculates the right length of the non-updated region located to the right of the updated region and the left length of the non-updated region located to the left of the updated region based on the horizontal coordinates to identify the right non-updated region and the left non-updated region.

Here, the image data processing device 110 can control dimming of the display device such that, when dimming weight information including a dimming weight value corresponding to a non-updated region is extracted from a dimming command, the dimming weight value is simultaneously applied to the upper non-updated region, the lower non-updated region, the right non-updated region, and the left non-updated region among the image frames displayed on the display device.

In another embodiment, the image data processing device 110 can, when dimming region identification information is extracted from a dimming command, obtain information for determining the number of divisions of non-updated regions other than the update region where the updated image content is located from the dimming region identification information and dimming on/off of each non-updated region divided according to the number of divisions, divide the non-updated region into a plurality of divided regions based on the number of divisions of the non-updated region, and determine dimming on/off for each of the divided regions based on the information for determining dimming on/off.

Here, the image data processing device 110 can control dimming of the display device such that dimming is simultaneously applied to the divided regions determined to be dimming-on among the image frames displayed on the display device based on the dimming weight values when dimming weight information including the dimming weight values corresponding to each divided region is extracted from the dimming command after dimming on/off is determined for each divided region among the non-updated regions.

In another embodiment, the image data processing device 110 can obtain the coordinates of the area where the updated image content is located, confirm the location of the updated region, and independently divide and identify the non-updated region into a plurality of divided regions based on the location of the updated region.

As another embodiment, when the update region information includes only the vertical coordinates of the region where the updated image content is located, the image data processing device 110 can calculate the upper length of the non-updated region located above the updated region and the lower length of the non-updated region located below the updated region based on the vertical coordinates to identify the upper non-updated region and the lower non-updated region.

Here, when the dimming weight information is not extracted from the dimming command, the image data processing device 110 can generate a new dimming weight value to be applied to the upper non-updated region and the lower non-updated region based on the luminance value of the updated region, and control dimming of the display device based on the new dimming weight value such that dimming is simultaneously applied to the upper non-updated region and the lower non-updated region among the image frames displayed on the display device.

In some cases, when dimming weight information including dimming weight values corresponding to the upper non-updated region and the lower non-updated region is extracted from the dimming command, the image data processing device 110 can control dimming of the display device such that dimming is simultaneously applied to the upper non-updated region and the lower non-updated region among the image frames displayed on the display device based on the dimming weight values.

In another embodiment, when dimming weight information including dimming weight values corresponding to an upper non-updated region and a lower non-updated region is extracted from a dimming command, the image data processing device 110 calculates a change amount between a current frame and a previous frame, checks whether the calculated change amount is less than a threshold value, and when the change amount is less than the threshold value, selects a left non-updated region located to the left of the updated region and a right non-updated region located to the right of the updated region as dimming areas, and determines dimming weight values for the left non-updated region and the right non-updated region based on the calculated change amount.

Here, the image data processing device 110 controls the dimming of the display device such that dimming is simultaneously applied to the upper non-updated region and the lower non-updated region among the image frames displayed on the display device based on the dimming weight value included in the dimming weight information, and controls the dimming of the display device such that dimming is simultaneously applied to the left non-updated region and the right non-updated region among the image frames displayed on the display device based on the dimming weight value determined corresponding to the calculated amount of change.

In this way, the present disclosure, through various embodiments, can reduce power consumption and provide a natural image to the user by actively or passively controlling edge dimming for the non-updated region among the image frames based on image information.

The above-described disclosure can be implemented as computer-readable code on a program-recorded medium. Computer-readable media include all types of recording devices that store data readable by a computer system. Examples of computer-readable media include hard disk drives (HDDs), solid-state disks (SSDs), silicon disk drives (SDDs), ROMs, RAMs, CD-ROMs, magnetic tapes, floppy disks, and optical data storage devices. Furthermore, the computer can include a processor of an artificial intelligence device.

### Industrial Applicability

The edge dimming control device according to the present disclosure has significant industrial applicability because it actively or passively controls edge dimming for non-updated regions of an image frame based on image information, thereby reducing power consumption and providing natural images to the user.

What is claimed is:

1. An edge dimming control device for controlling dimming of a display device, comprising:
a source module configured to provide a dimming command for an image frame; and
a sink module configured to control dimming of the display device based on the dimming command,
wherein the sink module is configured to, when the dimming command is input, obtain an updated region and a non-updated region of the image frame based on the dimming command, determine whether the non-updated region is identified, calculate a dimming weight for the non-updated region when the non-updated region is identified, and control dimming of the display device such that edge dimming is applied to the non-updated region of the image frame based on the calculated dimming weight.

2. The edge dimming control device of claim 1, wherein the source module is configured to provide the dimming command including updated region information indicating an updated region in which updated image content is located in the image frame.

3. The edge dimming control device of claim 2, wherein the source module is configured to provide the dimming command further including at least one of dimming weight information, dimming time information, and dimming region identification information.

4. The edge dimming control device of claim 1, wherein the sink module is configured to, when the dimming command is input, extract updated region information indicating an updated region in which updated image content is located from the dimming command, and obtain the updated region and the non-updated region of the image frame based on the extracted updated region information.

5. The edge dimming control device of claim 4, wherein the sink module is configured to, when both vertical and horizontal coordinates of a region in which the updated image content is located are included in the updated region information, identify an upper non-updated region and a lower non-updated region by calculating an upper length of a non-updated region located above the updated region and a lower length of a non-updated region located below the updated region based on the vertical coordinates, and identify a right non-updated region and a left non-updated region by calculating a right length of a non-updated region located to the right of the updated region and a left length of a non-updated region located to the left of the updated region based on the horizontal coordinates.

6. The edge dimming control device of claim 5, wherein the sink module is configured to, when dimming weight information including a dimming weight value corresponding to the non-updated region is extracted from the dimming command, control dimming of the display device such that dimming is simultaneously applied to the upper, lower, right, and left non-updated regions of the image frame displayed on the display device based on the dimming weight value.

7. The edge dimming control device of claim 4, wherein the sink module is configured to, when dimming region identification information is extracted from the dimming command, obtain, from the dimming region identification information, information for the number of divisions of the non-updated regions excluding the updated region in which the updated image content is located, and for determining dimming on/off of each non-updated region divided corresponding to the number of divisions, divide the non-updated region into a plurality of divided regions based on the number of divisions of the non-updated region, and determine dimming on/off of each of the divided regions based on the information for determining dimming on/off.

8. The edge dimming control device of claim 7, wherein the sink module is configured to, after dimming on/off of each of the divided regions among the non-updated regions is determined, when dimming weight information including a dimming weight value corresponding to each of the divided regions is extracted from the dimming command, control dimming of the display device such that dimming is simultaneously applied to divided regions determined as dimming on in the image frame displayed on the display device based on the dimming weight value.

9. The edge dimming control device of claim 4, wherein the sink module is configured to, when dimming region identification information is not extracted from the dimming command, identify a location of the updated region by obtaining coordinates of a region in which the updated image content is located, and autonomously divide the non-updated region into a plurality of divided regions based on the location of the updated region.

10. The edge dimming control device of claim 9, wherein the sink module is configured to, when autonomously dividing the non-updated region into the plurality of divided regions, divide the non-updated region into a second divided region located above the updated region, a fourth divided region located to the left of the updated region, a sixth divided region located to the right of the updated region, and an eighth divided region located below the updated region based on coordinate information of the updated region, and further divide a first divided region located diagonally upper-left of the updated region, a third divided region located diagonally upper-right of the updated region, a seventh divided region located diagonally lower-left of the updated region, and a ninth divided region located diagonally lower-right of the updated region based on the second, fourth, sixth, and eighth divided regions.

11. The edge dimming control device of claim 10, wherein the sink module is configured to, when dimming weight information including dimming weight values corresponding to the second, fourth, sixth, and eighth divided regions is extracted from the dimming command, control dimming of the display device such that dimming is simultaneously applied to the second, fourth, sixth, and eighth divided regions of the image frame displayed on the display device based on the dimming weight values, generate new dimming weight values to be applied to the first, third, seventh, and ninth divided regions based on the dimming weight values corresponding to the second, fourth, sixth, and eighth divided regions, and control dimming of the display device such that dimming is simultaneously applied to the first, third, seventh, and ninth divided regions based on the new dimming weight values.

12. The edge dimming control device of claim 4, wherein the sink module is configured to, when only vertical coordinates of a region in which the updated image content is located is included in the updated region information, identify the upper non-updated region from the lower non-updated region by calculating an upper length of a non-updated region located above the updated region and a lower length of a non-updated region located below the updated region based on the vertical coordinates.

13. The edge dimming control device of claim 12, wherein the sink module is configured to, when dimming weight information is not extracted from the dimming command, generate new dimming weight values to be applied to the upper and lower non-updated regions based on a luminance value of the updated region, and control dimming of the display device such that dimming is simultaneously applied to the upper and lower non-updated regions of the image frame displayed on the display device based on the new dimming weight values.

14. The edge dimming control device of claim 12, wherein the sink module is configured to, when dimming weight information including dimming weight values corresponding to the upper and lower non-updated regions is extracted from the dimming command, control dimming of the display device such that dimming is simultaneously applied to the upper and lower non-updated regions of the image frame displayed on the display device based on the dimming weight values.

15. The edge dimming control device of claim 12, wherein the sink module is configured to, when dimming weight information including dimming weight values corresponding to the upper and lower non-updated regions is extracted from the dimming command, calculate a variation between a current frame and a previous frame, determine whether the calculated variation is less than a threshold value, when the calculated variation is less than the threshold value, select a left non-updated region located to the left of the updated region and a right non-updated region located to the right of the updated region as dimming regions, and determine dimming weight values for the left and right non-updated regions based on the calculated variation.

16. The edge dimming control device of claim 15, wherein the sink module is configured to control dimming of the display device such that dimming is simultaneously applied to the upper and lower non-updated regions of the image frame displayed on the display device based on the dimming weight values included in the dimming weight information, and to control dimming of the display device such that dimming is simultaneously applied to the left and right non-updated regions based on the dimming weight values determined corresponding to the calculated variation.

17. The edge dimming control device of claim 1, wherein the sink module is configured to, when controlling dimming of the display device, control dimming of the display device by adjusting at least one of pixel data of a display panel and luminance data of a backlight based on a panel type of the display device.

18. The edge dimming control device of claim 1, wherein the sink module comprises:
an analyzer configured to analyze the dimming command when the dimming command is input;
a region divider configured to obtain an updated region and a non-updated region of the image frame based on the analyzed dimming command, and to divide the non-updated region into a plurality of divided regions;
a region determiner configured to determine a divided region to be dimmed among the plurality of divided regions;
a weight calculator configured to calculate a dimming weight to be applied to the divided region to be dimmed; and
a dimming applicator configured to control dimming of the display device such that edge dimming is applied to the non-updated region of the image frame based on the calculated dimming weight.

19. An edge dimming control method of an edge dimming control device, comprising:
receiving an image frame and a dimming command;
analyzing the dimming command;
obtaining an updated region and a non-updated region of the image frame based on the dimming command, and determining whether the non-updated region is divided and identified into a plurality of divided regions;
determining a divided region to be dimmed among the plurality of divided regions when the non-updated region is divided into the plurality of divided regions;
calculating a dimming weight to be applied to the divided region to be dimmed;
applying edge dimming to the non-updated region of the image frame based on the calculated dimming weight; and
controlling dimming of the display device such that the applied edge dimming is output.

20. A display device, comprising:
a display configured to display an image; and
an edge dimming control device configured to control dimming of the display,
wherein the edge dimming control device comprises:
a source module configured to provide a dimming command for an image frame; and
a sink module configured to control dimming of the display device based on the dimming command,
wherein the sink module is configured to, when the dimming command is input, obtain an updated region and a non-updated region of the image frame based on the dimming command, determine whether the non-updated region is identified, calculate a dimming weight for the non-updated region when the non-updated region is identified, and control dimming of the display such that edge dimming is applied to the non-updated region of the image frame based on the calculated dimming weight.
